(19) United States
(12) Patent Application Publication
(10) Pub. No.: US 2022/0138675 A1
(43) Pub. Date: May 5, 2022

(54) SYSTEM AND METHOD FOR DISPLAY AND VERIFICATION OF VEHICLE AND VEHICLE RECORDS

(71) Applicant: Nomaly Holdings Corporation, Plano, TX (US)

(72) Inventor: Scott Heninger, Prosper, TX (US)

(73) Assignee: Nomaly Holdings Corporation, Plano, TX (US)

(21) Appl. No.: 17/511,329

(22) Filed: Oct. 26, 2021

Related U.S. Application Data
(60) Provisional application No. 63/108,011, filed on Oct. 30, 2020.

(51) Int. Cl. G06Q 10/08; G06Q 20/02; G06Q 20/20; G06Q 20/36

(52) U.S. Cl. CPC G06Q 10/087; G06Q 20/3672; G06Q 20/203; G06Q 20/02

(57) ABSTRACT

In one aspect, the invention provides a system for displaying a vehicle of interest to a user. The system includes receiving an input query from the use for a vehicle of interest, following which a vehicle database is accessed to obtain vehicle records of the vehicle of interest from a blockchain. Then, an imaging device is accessed on the physical vehicle. The imaging device is then used to image and/or scan physical objects and images such as vehicle identification number (VIN), a barcode, a QR code, an odometer, specific vehicle parts, and the like, and combinations thereof. The images and/or the scans are then used to verify the vehicle's identity and its details. In another aspect, the invention provides a method to display a vehicle of interest to the user. In yet another aspect, the invention provides a method to modify vehicle records by an authorized user.

### CROSS-REFERENCE TO RELATED APPLICATIONS

This patent application claims the benefit of U.S. Provisional Patent Application No. 63/108,011, filed Oct. 30, 2020, which is incorporated herein by reference.

### TECHNICAL FIELD OF THE INVENTION

The present application relates to a system, a computer implemented method and a software application for vehicles, and more particularly for providing details of vehicles of interest to a user wherein the vehicle records are integrated with blockchain technology, along with corresponding real-time images or videos of the vehicles.

### BACKGROUND

Many sites exist for cars or vehicles to be sold. In a number of listings, owners tout the ability to trace or track maintenance on their vehicle as a positive aspect as it provides an in-depth history of the vehicle and the service the vehicle was provided over its life. While this service information is very useful, it is often difficult to maintain as an owner. Traditional records that are maintained on paper tend to get lost. Receipts don't print well, and those that are printed often fade over time. Organizing all the service information is difficult or it becomes a stack of papers without a good way to sort through. This is especially tedious when the vehicle gets older. This service information is useful but it is not accessible or usually provided to the potential buyer in a way that is useful.

Blockchain is becoming well known and almost expected in some industries, such as the food industry where steps are being taken to use this technology as a means to trace the food from farm to table. Its applicability in the car industry is not very well known.

Although strides have been made with respect to tracking vehicle conditions and service over time, shortcomings remain. It is desired that an application be provided that is usable for both the owner and a potential buyer for presenting an overall condition and history of the particular vehicle in a reliable manner.

### BRIEF DESCRIPTION OF THE INVENTION

In one aspect, the invention provides a system for displaying vehicle records to a user. The system comprises a network interface configured to interface with a processor, a memory configured to store non-transitory computer executable instructions and configured to interface with the processor; and the processor configured to interface with the memory. The processor is configured to execute the non-transitory computer executable instructions to cause the system to receive a query from the user related to a vehicle of interest. Then a vehicle database comprising one or more vehicle records is accessed, wherein each vehicle record is associated with a plurality of attributes. Subsequently, a record history blockchain associated with vehicles with at least one attribute that matches the query is accessed, based on the results, the vehicle of interest is identified, and the record history blockchain associated with the vehicle of interest is accessed. Then, at least one imaging device on the vehicle of interest is accessed to obtain at least one of a real-time image, a real-time video or both of the vehicle of interest. The record history and the at least one of the real-time image, the real-time video or both is displayed to the user.

In another aspect, the invention provides a computer implemented method to display a record of a vehicle of interest to a user. The method comprises receiving, via one or more processors and/or associated transceivers, a query from the user related to a vehicle of interest, and accessing, at a memory, a vehicle database comprising one or more vehicle records, wherein each vehicle record is associated with a plurality of attributes and a record history blockchain associated with vehicles whose at least one attribute match the query. The method then includes identifying the vehicle of interest and accessing the record history blockchain associated with the vehicle of interest. The method further comprises accessing at least one imaging device on the vehicle of interest to obtain at least one of a real-time image, a real-time video or both of the vehicle of interest. Then, the vehicle record history and at least one of the real-time image, the real-time video, or both is displayed to the user.

In yet another aspect, the invention provides a computer implemented method to modify a vehicle record by a user. The method comprises the steps involved in the method of the invention to display a record of a vehicle of interest to an authorized user, followed by allowing the user to modify the vehicle record.

### DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a view of a schematic showing a blockchain vehicle identification system according to an embodiment of the present application.

FIG. 2 is a schematic of an exemplary electronic device used to carry out the functions of the blockchain vehicle identification system of FIG. 1.

While the application is susceptible to various modifications and alternative forms, specific embodiments thereof have been shown by way of example in the drawings and are herein described in detail. It should be understood, however, that the description herein of specific embodiments is not intended to limit the application to the particular forms disclosed, but on the contrary, the intention is to cover all modifications, equivalents, and alternatives falling within the spirit and scope of the application as described herein.

### DETAILED DESCRIPTION

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

As noted herein, in one aspect the invention provides a system for displaying vehicle records to a user. The system is best implemented as a software or a mobile application operable via an electronic device that comprises a network interface configured to interface with a processor, a memory configured to store non-transitory computer executable instructions and configured to interface with the processor; and the processor configured to interface with the memory. Additionally, the system is described with respect to vehicles. However, it would be obvious to one skilled in the art that with simple modifications, the system can be adjusted to feasibly work with other equipment such as tractors, construction equipment, machinery, and so on.

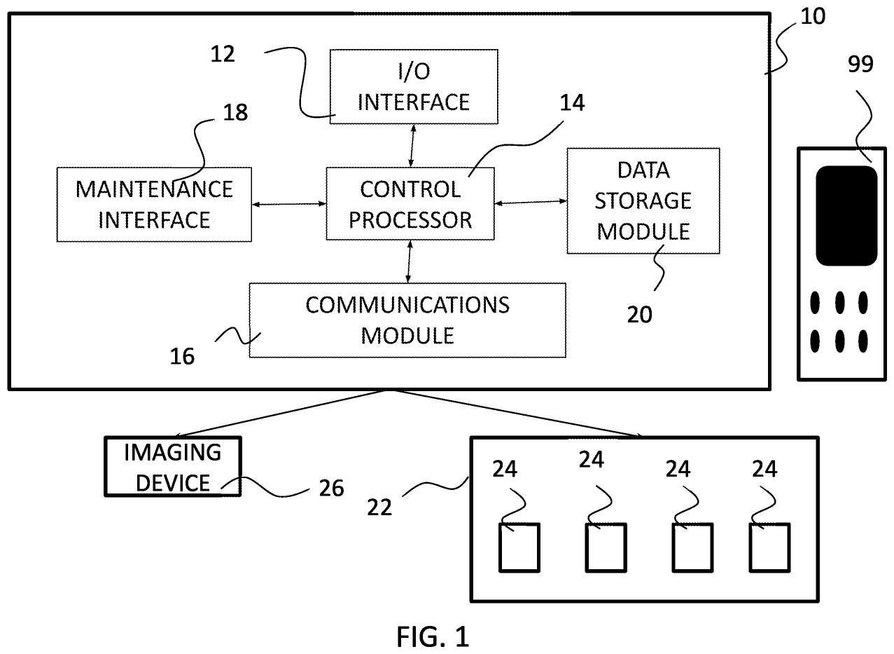

FIG. 1 is a block diagrammatic representation of the system of the invention, represented by numeral 10 and includes an input/output (I/O) interface 12, a control processor 14, a communications module 16, a maintenance interface 18, and a data storage module 20. Alternative embodiments can combine or distribute the input/output (I/O) interface 12, the control processor 14, the communications module 16, the maintenance interface 18, and the data storage module 20 as desired. In FIG. 1, a representative electronic device 99 that is capable of running system 10 is shown.

Embodiments of the system 10 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers include a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore, the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the system 10. The I/O interface 12 is in communication with the control processor 14 and is configured to provide an interactive link between users and remote parties. The I/O interface 12 can be configured for allowing one or more users to input information to the system 10 via any known input device. Examples can include a keyboard, mouse, touch screen, microphone, camera capable of enabling facial recognition and/or iris recognition, and/or any other desired input device. The I/O interface 12 provides a display portal defining a plurality of visually perceptible elements corresponding to the prediction data. The I/O interface 12 can be configured for allowing one or more users to receive information output from the system 10 via any known output device. Examples can include a display monitor, a printer, a speaker, and/or any other desired output device. The I/O interface 12 can be configured for allowing other systems to communicate with the system 10. For example, the I/O interface 12 can allow one or more remote computer(s) to access information, input information, and/or remotely instruct the system 10 to perform one or more of the tasks described herein. The I/O interface 12 can be configured for allowing communication with one or more remote data sources. For example, the I/O interface 12 can allow one or more remote data source(s) to access information, input information, and/or remotely instruct the system 10 to perform one or more of the tasks described herein.

The control processor 14 can be configured to perform a process or a plurality of processes such as the processes described below in connection with the associated Figures. Additionally, control processor 14 includes software programmed to properly communicate with the interested parties. Processor 14 includes a non-transitory computer-readable medium with instructions stored thereon to execute predetermined steps. Various functions of the control processor 14 may be realized, such as uploading and downloading of visual data, compilation and submission of requests, compilation and submission of data, interaction with social media, determining the rank or points value of vehicles, and titling vehicles with government entities.

The communications module 16 include any kind of communication technology known to one of ordinary skill in the art, which may include for example network that may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, cellular data networks such as 2G/3G/4G, etc., or an IEEE 802.11-based radio frequency network. Depending on the nature of communications module used, a transmitter-receiver combination or a transceiver may be utilized to achieve the purpose.

The maintenance interface 18 is configured to allow users to maintain desired operation of the system 10. In some embodiments, the maintenance interface 18 can be configured to allow for reviewing and/or revising the data stored in the data storage module 20 and/or performing any suitable administrative tasks commonly associated with database management. This can include, for example, updating database management software, revising security settings, and/or performing data backup operations. In some embodiments, the maintenance interface 18 can be configured to allow for maintenance of the control processor 14 and/or the I/O interface 12. This can include, for example, software updates and/or administrative tasks such as security management and/or adjustment of certain tolerance settings.

The data storage module 20 provides persistent data storage (computer readable storage media, i.e. hardware) for system 10. The data storage module 20 is in communication with control processor 14 and I/O interface 12. The phrase “data storage module” is used to represent any kind of a memory device or other suitable data storage arrangement may provide the functionality of the data storage, including cloud storage. In alternative embodiments, the data storage module 20 can be integral to or separate from the system 10 and can operate on one or more computers. The data storage module 20 preferably provides non-volatile data storage for any information suitable to support the operation of the system 10, including various types of data necessary to perform the functions and feature discussed below.

The system is accessible by a user to receive an input through the I/O interface 12. Typical inputs include vehicle identifiers such as, but not limited to, make, model, color, used or new, mileage, vehicle identification number, and the like, and combinations thereof The system may include several features such as a login ID and a password to be input by the user, which may further be preceded by a registration step. This registration may include obtaining critical steps such as but not limited to, full name, date of birth, email address, mobile number, address, and the like, and combinations thereof Any number of modes of verification or steps for verification is possible.

Once logged into the system 10, the user can enter a query for a vehicle through the I/O interface 12 to view details about the particular vehicle. The system 10 accesses a vehicle database 22 comprising one or more vehicle records 24. Each vehicle record is associated with a plurality of attributes, such as, but not limited to, make, model, color, used or new, mileage, vehicle identification number, and the like, and combinations thereof. In some embodiments, each vehicle is associated with a Digital Vehicle Identification Number (DVIN), which in turn is associated with the VIN. The DVIN may be used to assist with digital titling or registration when enabled.

Based on the query from the user, a record history blockchain associated with the one or more vehicles of interest whose at least one attribute matches the query is then accessed. The system 10 may be configured for the user to view the results of the query individually and/or collectively through one or more interfaces or displays. In this manner, the details of the vehicle of interest are shown to the user in a secure manner. This may include, for example, but not limited, besides the vehicle attributes such as make, model, color, vehicle identification number, and so on. This information can extend to acts done to the vehicle to enhance or maintain its condition, such as service history, accident history, overall condition, mileage, replacement parts used, and the like, and combinations thereof. Images of the vehicle may be incorporated as well.

The system 10 then accesses an imaging device 26 to be viewed in real-time by the user. In one exemplary embodiment, the imaging device is used to scan a barcode or a QR code made available on the vehicle of interest that is used to encrypt suitable vehicle details in order to verify the details on the vehicle record 24. In another exemplary embodiment, the imaging device is used to scan the VIN, which is then used to verify the whether the record of the vehicle of interest from the vehicles database is the same as the vehicle being scanned. Furthermore, the imaging device can also be used to scan the odometer on the dashboard of the vehicle to verify the reading in real-time . In other embodiments, some parts of the vehicle such as a head lamp, engine, air conditioner, axle, tires, and so on may have their own barcode or QR code, which may also be scanned by the imaging device to extract details of that individual part. In this manner, the user can quickly verify in real-time whether the original part or a spurious “knock-off” is present in the vehicle, or if a replacement part is present, the exact date on which the replacement took place, and whether that date corresponds with the date on the vehicle records, and so on. The imaging device may be an integrated device such as a camera present on the exemplary electronic device 99, or may be an independent imaging device that connects to the electronic device running the system 10 through suitable means of communication known to one of ordinary skill in the art, such as Wi-Fi, Bluetooth, and so on.

Thus, the system 10 is configured to track vehicle service, accident information, and overall condition using a combination of vehicle records and real-time images and videos. This data is traced back to and tied to at least one of the DVIN, VIN, or both with blockchain technology.

In some embodiments, the system 10 includes the ability to process and interpret entry data in combination with vehicle data to generate a value score that more accurately represents a true value of the vehicle based upon its life, consistency of the records, and so forth. The value score can be weighted in various ways to emphasize and accentuate appropriate actions and conditions. The value score would be used by a user to arrive at an estimated buying or selling price for the vehicle. The value score can be a randomly assigned number along a range. The value score may be also represented and applied to the monetary value of the vehicle such that the actual monetary value of the vehicle is automatically adjusted in relation to the specific value score. The system 10 is also configured to assess at least vehicle usage, maintenance, and history to provide a value score to owners and potential buyers as a method of comparison and more in-depth analysis of value and condition.

The system 10 also incorporates the functionality of adding information related to a vehicle, such as recent reparations, an accident, maintenance updates such as periodic services, and the like. It will be obvious to one skilled in the art that the nature of credentials required to make changes to vehicle records would be different than those for one who only wants to view details of vehicles of interest. Thus, the system 10 includes levels of access, which may include, for example, administrator, manager, service personnel, salesperson, user, and the like. In this manner, administrator has the power to change the records based on certain inputs, a manager may access or upload one or more images, enter vehicle data, accident information, service data, and so forth related to the vehicle and its care, while service personnel can only update service records, while users can only view vehicle details. In one preferred embodiment, the system 10 will provide a dashboard that may include one or more sub-screens and may be presented in a plurality of different ways to assist in accessibility, filtering of the data, and ease of use. The input may also be done manually or automatically through various means known in the art, for example, using screen capture. The system 10 thus permits real-time entry and tracking of the vehicle and its condition. A user may access the system 10 at any time and upload or capture pertinent data in support of any and all entry data.

With respect to new entries or tasks performed on the vehicle, the system 10 permits the user to enter the distinction between the method of service. The user can select self-service where the user does the work, or alternatively the user can select a service entity to perform the work. In this case the user may reserve an appointment at a particular service provider location. The system 10 may provide preselected service locations and also permits the user to manually search for alternate locations of their choice. This function allows the system 10 to facilitate advertising functions wherein listed spots in system 10 for servicing may be purchased. No matter the method of service, a user can capture information from a receipt to enter into system 10. Further, the services available to the user may be selected from a predetermined categories of services accessed via a drop down menu on the system 10. For example, the services may include commonly performed tasks, such as oil changes, tune ups, tires, brakes, routine inspections and the like. Alternately, the service can be input manually by the user.

Thus, in this manner, at least a portion of the vehicle record is maintained on a blockchain ensuring security and integrity of the information presented, while at least another portion of the vehicle record is capable of being verified on a real-time basis using at least one of a scanner, a still image camera, a video camera or combinations thereof. Further, any additions, changes and/or modifications to the vehicle record are also stored on the blockchain, thus ensuring integrity of the information presented to a user.

The blockchain vehicle identification system of the present application is configured to provide an interactive and comprehensive history report of one or more vehicles. A user is able to enter into the application a particular vehicle and assign or report activities taken or performed on that vehicle over time. This allows the application to serve as a one-stop vehicle database for assessing vehicle quality and value. Various methods of digital capture are provided for the capturing of video and/or images related to vehicular history. Blockchain technology is used to link all activity related to the vehicle over the course of its life. The system in particular is configured to process and analyze the information reported to generate a vehicle point score that is useful to assess the value of the vehicle when compared to the level of care of the vehicle.

An example of use may be described as follows. A user may access their account in system 10 via a mobile device, tablet, or computer. The user enters login credentials to validate the user with a particular account. The user may see a vehicle of interest on a dashboard. The make/model/year of the vehicle may be shown as well as the VIN and other customary data. One or more pictures may be visible to the user as well. A real-time image or video of the vehicle is displayed to the user on the mobile device, tablet or computer. A barcode present on the vehicle is scanned by the imaging device which is then decoded by the system 10, from which the vehicle details are accessed. The system 10 will then verify the details of the vehicle with the decoded details.

The dashboard may further show the value score of the vehicle. The value score may be a stand-alone value on a scale or range. The monetary value of the vehicle may also be shown with and/or without adjustment from the value score. The value score may be based on service records, accident reports, time depreciation, and vehicle data. System 10 may provide insight to the user as to what is increasing or decreasing the value score or what can be done to increase the value score.

The user may use one or more menus or screens to view and adjust any of the data related to the vehicle. For example, the user may: capture images related to the vehicle like interior and exterior images of the vehicle and receipts for service; update vehicle data; report new log entries; view history reports, and so forth.

Other functions enabled through the system of the invention 10 include configuring it to communicate with other applications on remote electronic devices. In one exemplary embodiment, the system 10 is configured to communicate with state governments to assist with vehicular registration/titling. In other embodiments, the system 10 is configured to communicate with insurance companies, automotive dealers, and other relevant companies or entities.

In further embodiments, the system 10 allows for the generation of various types of vehicle history reports. These may be interactive in some instances. Thus, the blockchain technology allows system 10 to create a digital roadmap of the vehicle from assembly to death of the vehicle.

As noted herein, in another aspect, the invention provides a computer implemented method of displaying details of vehicles of interest to a user, wherein some pertinent details are made available on a blockchain, and further other pertinent details are made available on a real-time basis, thus enabling identifying the vehicles of interest and verifying the details in real-time .

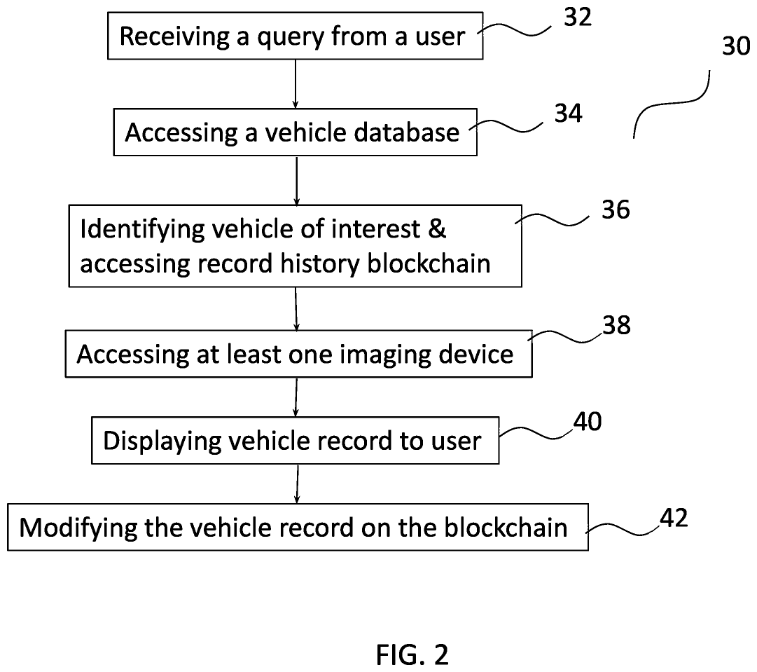

Referring now to FIG. 2, the computer implemented method of the invention is shown in a flowchart representation, and is generally depicted by numeral 30. The method comprises receiving, via one or more processors and/or associated transceivers, a query from the user related to a vehicle of interest as already described herein, shown in FIG. 2 by numeral 32. As noted already, there may be a step of logging into the system using a suitable device through known login methods, which may include, for example using a unique combination of username and password combination.

The method then involves accessing, at a memory, a vehicle database comprising one or more vehicle records, wherein each vehicle record is associated with a plurality of attributes, and then accessing a record history blockchain associated with vehicles whose at least one attribute matches the query, depicted by numeral 34 in FIG. 2. The method further comprises identifying the vehicle of interest and accessing the record history blockchain associated with the vehicle of interest, as shown by numeral 36 in FIG. 2. The method then includes the step of accessing at least one imaging device to obtain at least one of a real-time image, a real-time video or both of the vehicle of interest at step 38 in FIG. 2. The imaging device is used to obtain a real-time image or a video of the vehicle, or it is used to scan a barcode, QR code, or combinations thereof. The barcode or QR code may belong to the vehicle in general, or it may belong to a specific part of the vehicle, and the code may be used to indicate details about the part such as manufacturer's name, manufacturing date, installation date, and so on, and combinations thereof. Then, the vehicle record that includes its history and other details, and the at least one of the real-time image, the real-time video, or both is displayed to the user, as depicted by 40 in FIG. 2.

As already noted herein, based on the login credentials, a user may be authorized to make appropriate changes to the vehicle record, which changes will also be stored in the blockchain. Thus, in another aspect, the computer implemented method of the invention further includes a step of modifying the vehicle record on the blockchain, depicted by numeral 42 in FIG. 2.

The particular functions and features disclosed above are illustrative only, as the application may be modified and practiced in different but equivalent manners apparent to those skilled in the art having the benefit of the teachings herein. It is therefore evident that the particular functions and features disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof

What is claimed is:

1. A system for displaying vehicle records to a user, comprising:
a network interface configured to interface with a processor;
a memory configured to store non-transitory computer executable instructions and configured to interface with the processor; and
the processor configured to interface with the memory, wherein the processor is configured to execute the non-transitory computer executable instructions to cause the system to:
receiving a query from the user related to a vehicle of interest;
accessing a vehicle database comprising one or more vehicle records, wherein each vehicle record is associated with a plurality of attributes;
accessing a record history blockchain associated with vehicles whose at least one attribute matches the query;
identifying the vehicle of interest and accessing the record history blockchain associated with the vehicle of interest;
accessing at least one imaging device on the vehicle of interest to obtain at least one of a real-time image, a real-time video, or both of the vehicle of interest; and
displaying a record history and the at least one of the real-time image, the real-time video, or both to the user.

2. The system of claim 1, wherein the at least one imaging device is used to scan at least one of a barcode, a QR code, or combinations thereof.

3. The system of claim 1, wherein the at least one imaging device is used to scan a vehicle part to identify the vehicle part.

4. The system of claim 1, wherein the vehicle record comprises one or more of a vehicle identification number (VIN), make, model, color, vehicle usage, maintenance history, ownership history, service records, or combinations thereof.

5. The system of claim 1, wherein the vehicle record further comprises a digital vehicle identification record (DVIN).

6. The system of claim 1, wherein the vehicle record further comprises a value score.

7. The system of claim 6, wherein the value score is used to assess a value of the vehicle.

8. The system of claim 1, further comprising a reporting module.

9. A computer implemented method to display a record of a vehicle of interest to a user, the method comprising:
receiving, via one or more processors and/or associated transceivers, a query from the user related to the vehicle of interest;
accessing, at a memory, a vehicle database comprising one or more vehicle records, wherein each vehicle record is associated with a plurality of attributes;
accessing, at the memory, a record history blockchain associated with vehicles whose at least one attribute matches the query;
identifying the vehicle of interest and accessing the record history blockchain associated with the vehicle of interest;
accessing at least one imaging device on the vehicle of interest to obtain at least one of a real-time image, a real-time video or both of the vehicle of interest; and
displaying a record history and the at least one of the real-time image, the real-time video or both to the user.

10. The computer implemented method of claim 9, wherein the at least one imaging device is used to scan at least one of a barcode, a QR code, or combinations thereof

11. The computer implemented method of claim 9, wherein the at least one imaging device is used to scan a vehicle part to identify the vehicle part.

12. The computer implemented method of claim 9, wherein the vehicle record comprises one or more of a vehicle identification number (VIN), make, model, color, vehicle usage, maintenance history, ownership history, service records, and combinations thereof.

13. The computer implemented method of claim 9, wherein the vehicle record further comprises a digital vehicle identification record (DVIN).

14. The computer implemented method of claim 9, wherein the vehicle record further comprises a value score.

15. The computer implemented method of claim 14, wherein the value score is used to assess a value of the vehicle.

16. A computer implemented method to modify a vehicle record by an authorized user, the method comprising:
verifying credentials of a user;
receiving, via one or more processors and/or associated transceivers, a query from the authorized user related to a vehicle of interest;
accessing, at a memory, a vehicle database comprising one or more vehicle records, wherein each of the one or more vehicle records is associated with a plurality of attributes;
accessing, at the memory, a record history blockchain associated with vehicles whose at least one attribute matches the query;
identifying the vehicle of interest and accessing the record history blockchain associated with the vehicle of interest;
accessing at least one imaging device on the vehicle of interest to obtain at least one of a real-time image, a real-time video or both of the vehicle of interest;
displaying a record history and the at least one of the real-time image, the real-time video or both to the authorized user in order to verify vehicle details; and
allowing the authorized user to modify the vehicle record.

17. The computer implemented method of claim 16, wherein the at least one imaging device is used to scan at least one of a barcode, a QR code, or combinations thereof

18. The computer implemented method of claim 16, wherein the at least one imaging device is used to scan a vehicle part to identify the vehicle part.

19. The computer implemented method of claim 16, wherein the vehicle record comprises one or more of a vehicle identification number (VIN), make, model, color, vehicle usage, maintenance history, ownership history, service records, or combinations thereof

20. The computer implemented method of claim 16, wherein the vehicle record further comprises a digital vehicle identification record (DVIN).

21. The computer implemented method of claim 16, wherein the vehicle record further comprises a value score.

22. The computer implemented method of claim 21, wherein the value score is used to assess a value of the vehicle.
